(19) United States
(12) Patent Application Publication
(10) Pub. No.: US 2018/0276202 A1
(43) Pub. Date: Sep. 27, 2018

(54) METHOD AND SERVER FOR PROVIDING AUTOMATIC TRANSLATION IN ON-LINE CHAT SERVICE USING MULTIPLE LANGUAGES

(71) Applicant: NHN Entertainment Corporation, Seongnam-si (KR)

(72) Inventors: Changyol BAEK, Seongnam-si (KR); Keonwoo Kim, Seongnam-si (KR); Sungpark Kim, Seongnam-si (KR); Seul-gi Seong, Seongnam-si (KR); Yujin Jeon, Seongnam-si (KR); Junhyun Kim, Seongnam-si (KR)

(21) Appl. No.: 15/928,457

(22) Filed: Mar. 22, 2018

(30) Foreign Application Priority Data
Mar. 24, 2017 (KR) 10-2017-0037510

(51) Int. Cl. G06F 17/28; G06F 17/27

(52) U.S. Cl. CPC G06F 17/289; G06F 17/275

(57) ABSTRACT

An automatic translation providing server includes an identification unit to identify a plurality of languages set by a plurality of user terminals connected with an on-line chat service; a reception unit to receive an input message from at least one of the user terminals; a translation unit to translate the input message into each of the languages respectively set by the plurality of user terminals; and a providing unit to provide the input message and contents of messages translated into each of the languages respectively set by the plurality of user terminals to the on-line chat service. Automatic translation providing methods using the automatic translation providing server are also disclosed.

### CROSS REFERENCE TO RELATED APPLICATION

This application claims priority from and the benefit of Korean Patent Application No. 10-2017-0037510, filed on Mar. 24, 2017, which is hereby incorporated by reference for all purposes as if fully set forth herein.

### BACKGROUND

### Field

Exemplary implementations of the invention relate generally to on-line chat services, and more particularly, to a method and server for providing automatic translation in on-line chat service using multiple languages.

### Discussion of the Background

As the supply of mobile terminals including smartphones has recently and suddenly increased, various applications providing instant messaging service through mobile user terminals have emerged. Messages can be transmitted and received and various types of content can be shared through an application program (“app”) that provides an instant messaging service as described above. In particular, recently, persons who use various languages frequently converse with one another, e.g., due to the globalization of business, and a translation technology for communication between user using different languages has also rapidly developed.

Accordingly, apps that provide instant messaging service support various languages served in several countries. For example, Korean Patent No. 10-1271285 proposes a method of supporting multi-language translation for a message included in a chat room. However, in this patent, the translation of a language to be translated is provided when the language is selected at the end of a message and thus a message is translated only when a user participating in a chat room inputs the message.

The above information disclosed in this Background section is only for understanding of the background of the inventive concepts, and, therefore, it may contain information that does not constitute prior art.

### SUMMARY

Applicant recognized that when participants in an online chat room use a plurality of languages to converse with one another, it is advantageous for a main language to be set for each participant such that when a foreign language message is received, it can readily be translated into the main language of a corresponding participant.

Servers and methods for providing automatic translation in on-line chat service using multiple languages constructed according to exemplary implementations of the invention translate an input message into languages respectively set by a plurality of user terminals connecting the on-line chat service, thereby facilitating conversation, increasing the speed of conversation and/or improving and more efficiently using individual server and network resources.

Also, servers and methods for providing automatic translation in on-line chat service using multiple languages constructed according to exemplary implementations of the invention translate the input message based on the languages set by the plurality of user terminals and display the input messages and the contents of the translated messages together in the chat room of the on-line chat service.

Additional features of the inventive concepts will be set forth in the description which follows, and in part will be apparent from the description, or may be learned by practice of the inventive concepts.

According to one aspect of the invention, an automatic translation providing server includes an identification unit to identify a plurality of languages set by a plurality of user terminals connected with an on-line chat service; a reception unit to receive an input message from at least one of the user terminals; a translation unit to translate the input message into each of the languages respectively set by the plurality of user terminals; and a providing unit to provide the input message and contents of messages translated into each of the languages respectively set by the plurality of user terminals to the on-line chat service.

The providing unit may extract the contents of the messages translated into the languages respectively set by the plurality of user terminals by analyzing the input message and may provide the input message and the contents of the extracted and translated message to the screen of the on-line chat service of each user terminals.

The providing unit may query whether the contents of the message translated from the input message is to be displayed on the screen of the on-line chat service of the user terminal which has input the message and may provide contents of a message corresponding to results of the query.

The providing unit may provide the input message and all of the translations into the languages set by the plurality of user terminals connected with the on-line chat service to the screen of the on-line chat service of the user terminal which has input the message.

The providing unit may set a position of a message so that the input message is located at a higher position than the contents of the translated messages of the screen of the on-line chat service of the user terminal.

The providing unit may provide a chat history of messages executed in the on-line chat service by storing the input message and the contents of the message translated based on the language set by each user terminal.

The providing unit may search a chat history related to the on-line chat service for contents of a message related to a search word and contents of a message translated in accordance with the contents of the message related to the search word when the search word is input by a user terminal connected to the on-line chat service, and may provide the retrieved contents of the message as results of the search.

The identification unit may provide a user interface in the on-line chat service to input the plurality of languages set by a plurality of user terminals and sets a language to be translated based on a language input through the user interface.

After any one of the languages respectively set by the plurality of user terminals is changed, the translation unit may translate contents of a message based on the changed language.

According to another aspect of the invention, an automatic translation providing method includes the steps of identifying a plurality of languages set by a plurality of user terminals connected with an on-line chat service, receiving the input message from at least one user terminal of the plurality of user terminals, translating the input message into each of the languages respectively set by the plurality of user terminals, and providing the input message and the contents of messages translated into the languages respectively set by the plurality of user terminals to the on-line chat service.

The step of providing the input message and contents of messages translated into each of the languages respectively set by the plurality of user terminals to the on-line chat service may include extracting the contents of the messages translated into the languages respectively set by the plurality of user terminals by analyzing the input message, and providing the input message and the contents of the extracted and translated message to the screen of the on-line chat service of each user terminals.

The step of providing the input message and contents of messages translated into each of the languages respectively set by the plurality of user terminals to the on-line chat service may include querying whether the contents of the message translated from the input message is to be displayed on the screen of the on-line chat service of the user terminal which has input the message, and providing the contents of a message corresponding to the results of the query.

The step of providing the input message and contents of messages translated into the languages respectively set by the plurality of user terminals to the on-line chat service may further include providing all of the translations into the languages set by the plurality of user terminals connected with the on-line chat service to the screen of the on-line chat service of the user terminal which has input the message.

The step of providing the input message and contents of messages translated into each of the languages respectively set by the plurality of user terminals to the on-line chat service may include setting the position of a message so that the input message is located at a higher position than the contents of the translated messages of the screen on the on-line chat service of the user terminal.

The step of providing the input message and contents of messages translated into each of the languages respectively set by the plurality of user terminals to the on-line chat service may include providing the chat history of messages executed in the on-line chat service by storing the input message and the contents of the message translated based on the language set by each user terminal.

The step of may further include searching a chat history related to the on-line chat service for the contents of a message related to a search word and the contents of a message translated in accordance with the contents of the message related to the search word when the search word is input by a user terminal connected to the on-line chat service, and providing the retrieved contents of the message as results of the search.

The step of identifying a plurality of languages set by a plurality of user terminals connected with an on-line chat service may include providing a user interface in the on-line chat service to input the plurality of languages set by a plurality of user terminals, and setting a language to be translated based on a language input through the user interface.

The step of translating the input message into the languages respectively set by the plurality of user terminals may include when any one of the languages respectively set by the plurality of user terminals is changed, translating the contents of a message based on the changed language.

The step of receiving an input message from at least one user terminal of the plurality of user terminals may include determining the language of the input message in the on-line chat service in which messages written in different languages are transmitted and received.

According to still another aspect of the invention, a computer program stored in a storage medium to execute an automatic translation providing method. The automatic translation providing method includes identifying a plurality of languages set by a plurality of user terminals connected with an on-line chat service, receiving the input message from at least one user terminal of the plurality of user terminals, translating the input message into each of the languages respectively set by the plurality of user terminals, and providing the input message and the contents of messages translated into the languages respectively set by the plurality of user terminals to the on-line chat service.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a schematic diagram of a network environment constructed according to an exemplary embodiment of the invention.

FIG. 2 is a block diagram of a processor in an automatic translation providing server constructed according to an exemplary embodiment of the invention.

FIG. 3 is a flowchart for illustrating an automatic translation providing method of the automatic translation providing server according to an exemplary embodiment.

FIG. 4 is a flowchart for illustrating a method of determining, by the automatic translation providing server, the language of a received message according to an exemplary embodiment.

FIG. 5 is an example screen shot for illustrating that the automatic translation providing server provides the results of the translation of a message input by a user terminal to a chat room.

FIG. 6 is an example screen shot for illustrating that the automatic translation providing server provides the results of the translation of a message to the chat screen of a user terminal.

FIG. 7 is an example screen shot for illustrating that the automatic translation providing server provides the results of search including a search word.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In exemplary embodiments, a server, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to one or more exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, a server, and/or one or more components thereof may include or otherwise be associated with one or more memories (not shown) including code (e.g., instructions) configured to cause a server, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CD-RW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

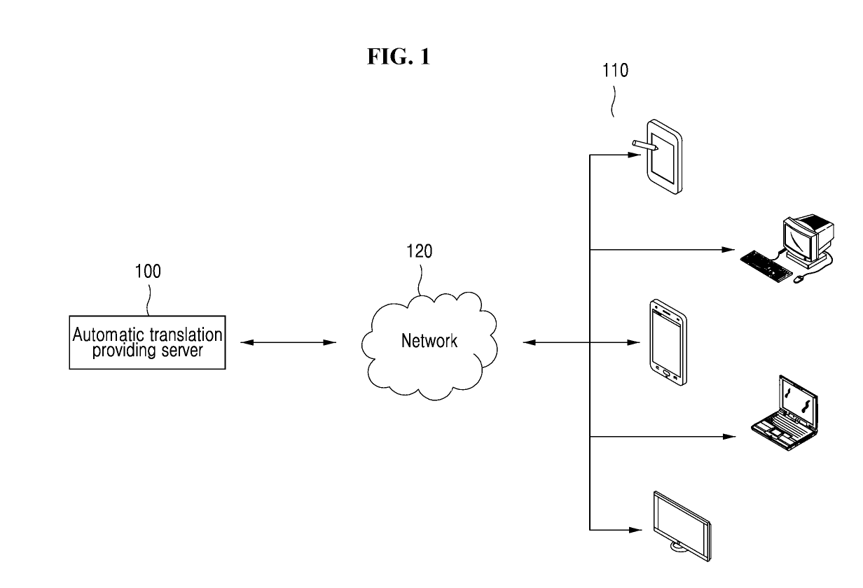

FIG. 1 is a schematic diagram of a network environment constructed according to an exemplary embodiment of the invention.

The network environment of FIG. 1 shows an example including a terminal 110, a server 100 and a network 120.

The terminal 110 may be a fixed terminal or mobile terminal implemented using a computer device. The terminal 110 may include a smartphone, a mobile phone, a navigator, a computer, a notebook, a terminal for digital broadcasting, personal digital assistants (PDA), a portable multimedia player (PMP), and a tablet PC, for example. For example, the terminal 110 may communicate with other terminals and/or the server 100 over the network 120 using a wired or wireless communication method.

The communication method is not limited, and may include short-distance wireless communication between devices in addition to a communication method using a communication network (e.g., a mobile communication network, wired Internet, wireless Internet, and a broadcasting network) which may be included in the network 120. For example, the network 120 may include one or more of a personal area network (PAN), a local area network (LAN), a campus area network (CAN), a metropolitan area network (MAN), a wide area network (WAN), a broadband network (BBN), and the Internet. Furthermore, the network 120 may include one or more of network topologies, including a bus network, a star network, a ring network, a mesh network, a star-bus network, and a tree or hierarchical network, but is not limited thereto.

The server 100 may be implemented using a computer device or a plurality of computer devices that provides commands, code, files, content and services through communication with the terminal 110 over the network 120 as is known in the art. For example, the server 100 may be an automatic translation providing server that includes hardware, software or a combination thereof that provides an automatic translation service to the terminal 110 connected thereto over the network 120.

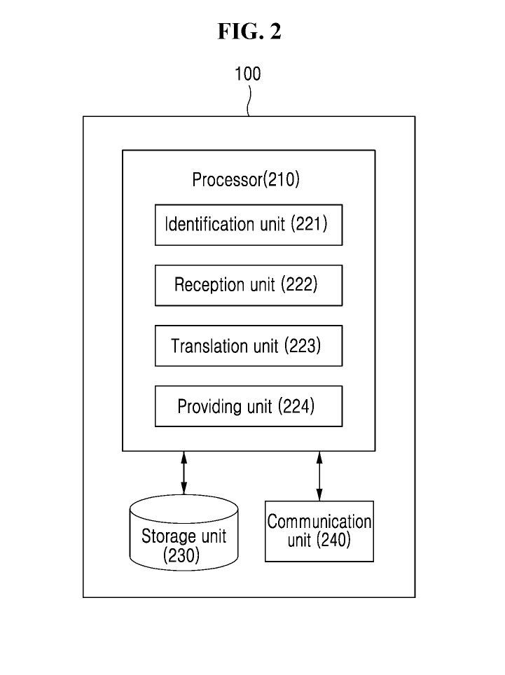

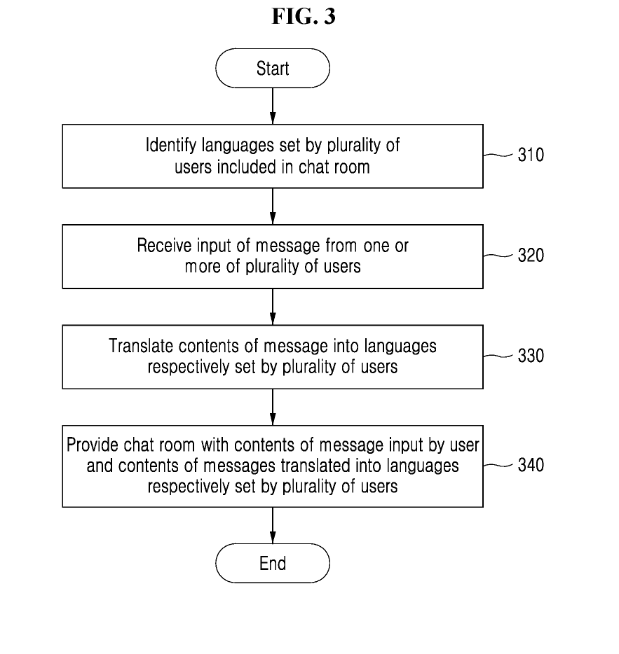

FIG. 2 is a block diagram of a processor in an automatic translation providing server constructed according to an exemplary embodiment of the invention. FIG. 3 is a flowchart for illustrating an automatic translation providing method of the automatic translation providing server according to an exemplary embodiment.

The automatic translation providing server 100 may include a processor 210 for providing the translation service, a storage unit 230 and a communication unit 240. The processor 210 of the automatic translation providing server 100 may include an identification unit 221, a reception unit 222, a translation unit 223 and a providing unit 224, each of which is composed of one or more software modules. Furthermore, the storage unit 230 may store and keep ID information of a user, information related to a message received from a user, and information related to the translations of the contents of a message. The communication unit 240 may transmit and receive messages between terminals.

The processor 210 and the elements of the processor 210 may control the automatic translation providing server so that it performs steps 310 to 340 includes in the automatic translation providing method of FIG. 3. In this case, the processor 210 and the elements of the processor 210 may be implemented to execute the code of an operating system included in memory and instructions according to the code of at least one program. In this case, the elements of the processor 210 may be the expressions of different functions performed by the processor 210 in response to a control command provided by program code stored in the automatic translation providing server 100.

The processor 210 may load program code, stored in the file of a program for the automatic translation providing method, into the memory. For example, when the program is executed in the automatic translation providing server 100, the processor may control the automatic translation providing server so that the program code is loaded from the file of the program to the memory under the control of the operating system.

At step 310, the identification unit 221 may identify languages set by a plurality of user terminals 110 (users) illustrated in FIG. 1 are connected to a chat room. The chat room is provided by an on-line chat service such as Kakaotalk or Naver Line and is displayed on a screen of each terminal 110 when an instant messaging service application is executed in each terminal 110. Users of the terminals 110 can communicate with the other users through the chat room if the terminals 110 are connected with the automatic translation providing server 100 that provides the on-line chat service. In addition, the chat room may also execute and display the translation service provided by the automatic translation server 100. In other words, the chat room is an on-line communication service that is displayed on at least two terminals 110 connected to the automatic translation server 100. When the chat room including the plurality of participants, e.g., users, is created, the plurality of users included in the chat room may transmit and receive messages in different languages. The chat room provides a user interface in which the plurality of users inputs languages to be used in the chat room. When a language to be translated is set based on a language received through the user interface, the identification unit 221 identifies the set language.

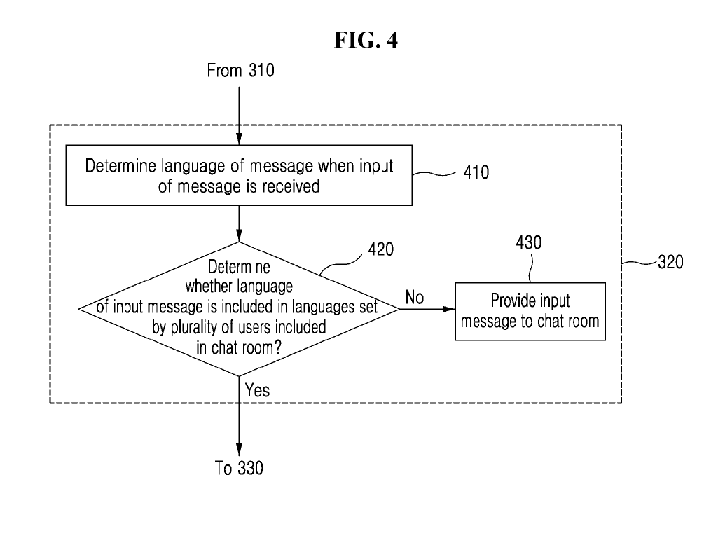

At step 320, the reception unit 222 may receive the input of a message from one or more of the plurality of users. FIG. 4 is a flowchart for illustrating a method of determining, by the automatic translation providing server, the language of a received message. At step 410, when the input of the message is received, the reception unit 222 may determine the language of the message. At step 420, the reception unit 222 may determine whether the language of the input message is included in the languages set by the plurality of users included in the chat room. If, as a result of the determination, it is determined that the language of the received message is included in the languages set by the plurality of users included in the chat room, the reception unit 222 may perform step 330. If, as a result of the determination, it is determined that the language of the received message is not included in the languages set by the plurality of users included in the chat room, the reception unit 222 does not perform translation and may provide the original text of the received message to the chat room.

For example, it is assumed that the languages set by the plurality of users included in the chat room include Korean, Japanese, English and Chinese. When the language of a message input by at least one of the plurality of users is detected in Japanese, it may be extracted as Japanese. In this case, when Japanese, that is, a language input by a user, is included in the language range (i.e., Korean, Japanese, English and Chinese) set in the chat room, the reception unit 222 may perform step 330 of providing the translation of the message.

At step 330, when the input of the message is received, the translation unit 230 may translate the contents of the message into the languages respectively set by the plurality of users. The translation unit 230 may translate the contents of the message into the languages respectively set by the plurality of users based on the language of the message input by the user. For example, if the language of the message input by the user is Japanese, the translation unit 230 may translate the message, written in Japanese, into messages corresponding to the language range set in the chat room, for example, Korean, Japanese, English and Chinese.

At step 340, the providing unit 224 may provide the chat room with the contents of the message input by the user and the contents of the messages translated into the languages respectively set by the plurality of users. For example, the providing unit 224 may provide the contents of the message input by the user and the contents of the translated messages corresponding to the languages set in the chat room to the chat screens of the respective users related to the chat room based on the languages set by the plurality of users included in the chat room. The providing unit 224 may query whether the contents of a message translated from the contents of the message input by the user will be displayed on the chat screen of the user who has input the message, and may provide the contents of the message corresponding to the results of the query. The providing unit 224 may provide the chat screen of the user who has input the message with the contents of the message input by the user and all of the translations of the languages set by the plurality of users included in the chat room based on the contents of the message input by the user.

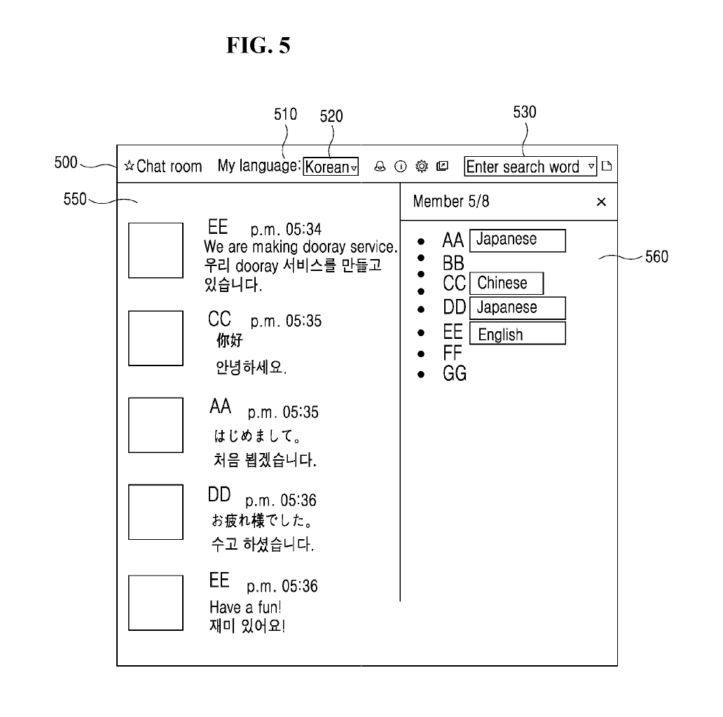

FIG. 5 is an example screen shot for illustrating that the automatic translation providing server provides the results of the translation of a message input by a user terminal to a chat room.

An operation of providing translation service for transmitted/received messages is described with reference to FIG. 5. A chat room 500 may be created through a device or app that provides a messenger function. In this case, the chat room 500 means the space in which users can communicate with one another, and provides instant messaging service such as Viber, Facebook Messenger, or Google Hangouts Meet. The chat room 500 allows 1:1 or 1:N (group) chatting. For example, when an initial user sends a message to one or more users through a messenger app, the chat room 500 may be created. One or more users who have received the message transmitted by the user may be invited to the chat room 500. The invited users act as members 560 of the chat room 500. Message can be transmitted and received through the chat room 500 including the initial user and one or more users that have received the message transmitted by the user, and the record of the transmission/reception of the messages may be stored in the chat room.

Alternatively, a message communication tool that provides the execution of a collaborative work process, such as Facebook At Work or Google Hangouts Chat, may provide a messenger function through which messages can be transmitted and received. The message communication tool performs the cooperation process, and enables the integrated use of tasks by recognizing a project, works related to a project, works, mail, a message, a schedule, a task tracker, a messenger, and documents as tasks and associating the tasks. Furthermore, the message communication tool enables cooperation between members who participate in tasks and enables the progress state of a task to be shared in real time. Accordingly, users can chat with one another using a method identical or similar to that described above through the messenger function provided by the message communication tool.

Described herein is a method of providing a translation service in the state in which as the message communication tool provides the messenger function, the person in charge or participants associated with a project are invited to a chat room to create a chat room and the person in charge or the participants invited to the chat room chat with one another using different languages. In this case, the person in charge who is associated with the project may mean a person who directly participates in the project, and the participant associated with the project may mean a person who indirectly participates in the project. For example, if a company performs a project, cooperative companies may be present in addition to the company. Accordingly, in order for persons associated with the project to exchange messages smoothly, the message communication tool may provide a messenger that provides instant messaging service.

The automatic translation providing server 100 may distinguish between a chat area 550 in which an input message from a user is displayed and a member area 560 in which information about a user participating in a chat room is provided. The automatic translation providing server may display a message input by a user and the translated message of the input message in the chat area 550, and may display information about a user participating in the chat room in the member area 560.

The automatic translation providing server 100 may display information about a user who has input a message and the message corresponding to the user in the chat area 550 together. Accordingly, messages present in the chat area 550 may be provided as a chat history.

The automatic translation providing server 100 may provide the member area 560 with at least one item of information, such as ID information, nicknames, positions, belongings, and languages of a plurality of users who participate in the chat room 500. Furthermore, the automatic translation providing server 100 may determine whether a member included in the chat room 500 accesses the message communication tool, and may separately display that a member who accesses the message communication tool is in an online access state. In other words, the automatic translation providing server may distinguish between a user who accesses the message communication tool and a user who does not access the message communication tool, and may display an online access state or an off-line state for the chat room. Alternatively, the automatic translation providing server may display the state (i.e., online or offline) of a user depending on whether the user has accessed a messenger provided by the message communication tool.

The automatic translation providing server 100 may provide a user interface 530 in which a search word is entered. When a user enters a search word through the user interface 530 in which a search word is entered, the automatic translation providing server 100 may search for the contents of a message including the search word based on a chat history stored in the chat room. The automatic translation providing server 100 may display the contents of the message including the search word on the chat screen.

In the example shown in FIG. 5, it is assumed that users including AA, BB, CC, DD, EE, FF, and GG are connected to the chat room 500. In this case, each of the users may set a language to be used in the chat room. For example, the automatic translation providing server 110 may provide a user interface 520 in which a plurality of users inputs languages to be used in the chat room. A language to be translated may be set based on a language selected through the user interface 520. AA may be set as Japanese, CC may be set as Chinese, DD may be set as Japanese, EE may be set as English, and a default language may be set as Korean. The remaining users (e.g., BB, FF, and GG) who have not set a language based on Korean may be automatically set as Korean.

In the chat room, a message may be input by one or more of the plurality of users. For example, EE may input a message in English. When the message input by EE is received, the automatic translation providing server may determine that the message has been input in English. The automatic translation providing server 110 may translate the contents of the message, input in English, into one or more of the languages set in the chat room. The automatic translation providing server may translate the contents of the message input in English into Korean, Japanese, and Chinese. For example, the translation of the message may be performed through an known application program interface (API) that provides translations.

The automatic translation providing server 110 may provide the chat room 500 with the contents of the message input in English and the contents of a message translated from the input message. The automatic translation providing server may provide the contents of a message input by a specific user and the contents of a message translated from the input message together in the chat room. The automatic translation providing server may provide a message input in relation to a user who has input a message and a message translated from the input message together.

The automatic translation providing server 110 may provide the chat screen of each user related to the chat room with the contents of a message input by a user and the contents of a translated message corresponding to a language set in the chat room. The automatic translation providing server may extract the contents of a message translated from the contents of a message input by each user in accordance with a language set by each user, and may provide the extracted contents of the translated message and the contents of the input message to the chat screen of each user. As described above, for example, it is assumed that a chat screen related to the chat room 500 of FIG. 5 is the chat screen of BB's terminal 110. If a language set by BB is Korean and the language of a message input by EE is English, the contents of the message input in English and the contents of a message translated into Korean may be displayed on the chat screen of BB.

Furthermore, the automatic translation providing server 110 may set the position of a message so that the contents of a message input by each user are displayed at a higher position than the contents of a translated message. Furthermore, the positions of the contents of an input message and the contents of a translated message may be set by the preferences of a user. The contents of an input message and the contents of a translated message may be displayed on a chat screen depending on a set position.

Furthermore, if a language to be used by a user included in the chat room is changed, the automatic translation providing server may translate the contents of a message input the chat room based on the changed language.

Furthermore, when another user is invited to the chat room, the automatic translation providing server may detect a language set by the invited user, and may translate an input message into the detected language. The automatic translation providing server may provide the contents of a message translated into the changed language to the chat room. Furthermore, the automatic translation providing server may change a chat history, including chatted messages, into the changed language and provide translated messages.

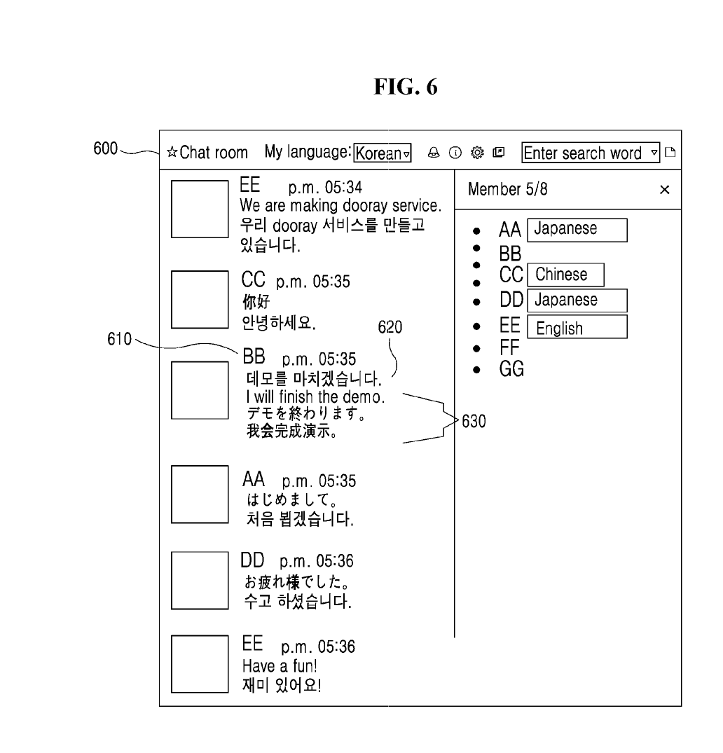

FIG. 6 is an example screen for illustrating that the automatic translation providing server provides the results of the translation of a message to the chat screen of a user terminal.

The automatic translation providing server 110 may provide the chat screen of each user related to a chat room with the contents of a message input by a user and the contents of a message translated in accordance with a language set in the chat room. In this case, when a message is input and when a message is not input, the contents of the messages are differently displayed on the chat screen.

FIG. 6 illustrates that translated results are provided to the chat screen of a user who has input a message. For example, it is assumed that the chat screen of FIG. 6 is the chat screen 600 of BB.

The automatic translation providing server 110 may provide the chat screen of a user's terminal (user) 610 who has input a message with the contents 620 of the message input by the user 610 and all of translations 630 translated into languages respectively set by a plurality of users included in a chat room based on the contents 620 of the message input by the user. For example, a message may be input by BB. If BB has set Korean as its main language, the message may be input in Korean. In this case, the message input by BB may be displayed on the chat screen 600 of BB in Korean. All of messages translated into languages (e.g., Chinese, Korean and English) set by a plurality of users included in the chat room may be displayed below the message input by BB.

In this case, the automatic translation providing server 110 may query whether the contents of the messages translated from the contents of the message input by the user will be displayed on the chat screen of the user who has input the message in addition to the contents of the message input by the user, and may provide the contents of a message corresponding to the results of the query. Furthermore, only some of the contents of all the translated messages may be configured to be selectively displayed in addition to the contents of the message input by the user, and only the contents of the configured translated message may be displayed on the chat screen.

As described above, when another user included in a chat room inputs a message based on a user (one's own), the automatic translation providing server may display the contents of the input message and the contents of a message translated into a language set by the user on a chat screen. Furthermore, when the user (one's own) inputs a message, the automatic translation providing server may display the contents of the input message and the contents of all of messages translated into languages respectively set by a plurality of users included in the chat room.

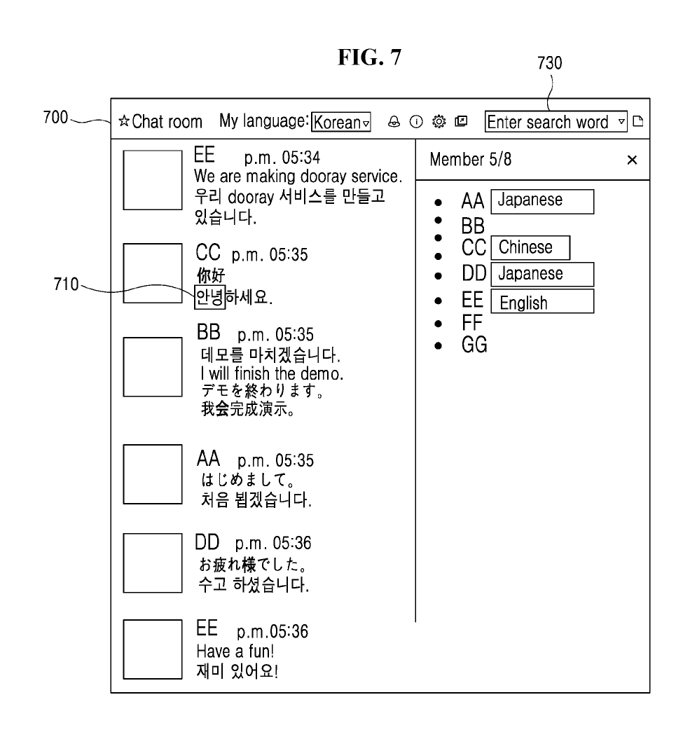

FIG. 7 is an example screen shot for illustrating that the automatic translation providing server provides the results of search including a search word.

The automatic translation providing server 110 may store the contents of a message input by a user and the contents of messages translated based on languages respectively set by users. The automatic translation providing server may provide the chat history of messages chatted in a chat room because the contents of the message input by the user and the contents of the translated messages.

A user may input a search word 730. When the user included in a chat room inputs the search word 730, the automatic translation providing server may search a chat history related to the chat room for the contents of a message related to the search word and the contents of a message translated in accordance with the contents of the message related to the search word. For example, the user may input “ [symbol] ”, that is, the search word 730. At this time, the automatic translation providing server may search a chat history stored in the chat room for a message including the search word “ [symbol] ” When the automatic translation providing server extracts the message including the search word “ [symbol] ” from the chat history, it may provide the contents of the message including the search word “ [symbol] ” as in 710.

The apparatus described above may be implemented in the form of a combination of hardware elements, software elements, and/or hardware elements and software elements. For example, the apparatus and elements described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configurations, such as a parallel processor, are also possible.

Software may include a computer program, code, an instruction or one or more combinations of them and may configure the processing device so that it operates as desired or may instruct the processing device independently or collectively. Software and/or data may be interpreted by the processing device or may be embodied in a machine, component, physical device, virtual equipment or computer storage medium or device of any type or a transmitted signal wave permanently or temporarily in order to provide an instruction or data to the processing device. Software may be distributed to computer systems connected over a network and may be stored or executed in a distributed manner. Software and data may be stored in one or more computer-readable recording media.

The methods according to the exemplary embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter.

The automatic translation providing server 110 according to an exemplary embodiment can translate the contents of a message more rapidly and use network resources more efficiently because it provides translation service for an input message based on languages set by a plurality of users included in a chat room.

The automatic translation providing server 110 according to an exemplary embodiment provides the contents of a message input by a counterpart and the contents of a message translated from the input message at the same time. Accordingly, a user can check the contents of the message more conveniently.

The automatic translation server 110 according to an exemplary embodiment translates a message written in a different language into a language set by a user when the message is received by the user, and provides the contents of the input message and the contents of the translated message, thereby facilitating conversation.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An automatic translation providing server, comprising:
an identification unit to identify a plurality of languages set by a plurality of user terminals connected with an on-line chat service;
a reception unit to receive an input message from at least one of the user terminals;
a translation unit to translate the input message into each of the languages respectively set by the plurality of user terminals; and
a providing unit to provide the input message and contents of messages translated into each of the languages respectively set by the plurality of user terminals to the on-line chat service.

2. The automatic translation providing server of claim 1, wherein the providing unit extracts the contents of the messages translated into the languages respectively set by the plurality of user terminals by analyzing the input message and provides the input message and the contents of the extracted and translated message to the screen of the on-line chat service of each user terminals.

3. The automatic translation providing server of claim 1, wherein the providing unit queries whether the contents of the message translated from the input message is to be displayed on the screen of the on-line chat service of the user terminal which has input the message and provides contents of a message corresponding to results of the query.

4. The automatic translation providing server of claim 3, wherein the providing unit provides the input message and all of the translations into the languages set by the plurality of user terminals connected with the on-line chat service to the screen of the on-line chat service of the user terminal which has input the message.

5. The automatic translation providing server of claim 1, wherein the providing unit sets a position of a message so that the input message is located at a higher position than the contents of the translated messages of the screen of the on-line chat service of the user terminal.

6. The automatic translation providing server of claim 1, wherein the providing unit provides a chat history of messages executed in the on-line chat service by storing the input message and the contents of the message translated based on the language set by each user terminal.

7. The automatic translation providing server of claim 6, wherein the providing unit searches a chat history related to the on-line chat service for contents of a message related to a search word and contents of a message translated in accordance with the contents of the message related to the search word when the search word is input by a user terminal connected to the on-line chat service, and provides the retrieved contents of the message as results of the search.

8. The automatic translation providing server of claim 1, wherein the identification unit provides a user interface in the on-line chat service to input the plurality of languages set by a plurality of user terminals and sets a language to be translated based on a language input through the user interface.

9. The automatic translation providing server of claim 1, wherein after any one of the languages respectively set by the plurality of user terminals is changed, the translation unit translates contents of a message based on the changed language.

10. An automatic translation providing method, comprising the steps of:
identifying a plurality of languages set by a plurality of user terminals connected with an on-line chat service;
receiving an input message from at least one user terminal of the plurality of user terminals;
translating the input message into each of the languages respectively set by the plurality of user terminals; and
providing the input message and contents of messages translated into the languages respectively set by the plurality of user terminals to the on-line chat service.

11. The automatic translation providing method of claim 10, wherein the step of providing the input message and contents of messages translated into each of the languages respectively set by the plurality of user terminals to the on-line chat service comprises:
extracting the contents of the messages translated into the languages respectively set by the plurality of user terminals by analyzing the input message, and
providing the input message and the contents of the extracted and translated message to the screen of the on-line chat service of each user terminal.

12. The automatic translation providing method of claim 10, wherein the step of providing the input message and contents of messages translated into each of the languages respectively set by the plurality of user terminals to the on-line chat service comprises:
querying whether the contents of the message translated from the input message is to be displayed on the screen of the on-line chat service of the user terminal which has input the message, and
providing contents of a message corresponding to results of the query.

13. The automatic translation providing method of claim 12, further comprising;
providing the input message and all of the translations into the languages set by the plurality of user terminals connected with the on-line chat service to the screen of the on-line chat service of the user terminal which has input the message.

14. The automatic translation providing method of claim 10, wherein the step of providing the input message and contents of messages translated into each of the languages respectively set by the plurality of user terminals to the on-line chat service comprises setting a position of a message so that the input message is located at a higher position than the contents of the translated messages on the screen of the on-line chat service of the user terminal.

15. The automatic translation providing method of claim 10, wherein the step of providing the input message and contents of messages translated into each of the languages respectively set by the plurality of user terminals to the on-line chat service comprises providing a chat history of messages executed in the on-line chat service by storing the input message and the contents of the message translated based on the language set by each user terminal.

16. The automatic translation providing method of claim 15, further comprising;
searching a chat history related to the on-line chat service for contents of a message related to a search word and contents of a message translated in accordance with the contents of the message related to the search word when the search word is input by a user terminal connected to the on-line chat service, and
providing the retrieved contents of the message as results of the search.

17. The automatic translation providing method of claim 10, wherein the step of identifying a plurality of languages set by a plurality of user terminals connected with an on-line chat service comprises:
providing a user interface in the on-line chat service to input the plurality of languages set by a plurality of user terminals, and
setting a language to be translated based on a language input through the user interface.

18. The automatic translation providing method of claim 10, wherein the step of translating the input message into the languages respectively set by the plurality of user terminals comprises, when any one of the languages respectively set by the plurality of user terminals is changed, translating contents of a message based on the changed language.

19. The automatic translation providing method of claim 10, wherein the step of receiving an input message from at least one user terminal of the plurality of user terminals comprises determining a language of the input message in the on-line chat service in which messages written in different languages are transmitted and received.

20. A computer program stored in a storage medium to execute an automatic translation providing method, wherein the automatic translation providing method comprises:
identifying a plurality of languages set by a plurality of user terminals connected with an on-line chat service;
receiving an input message from at least one user terminal of the plurality of user terminals;
translating the input message into each of the languages respectively set by the plurality of user terminals; and
providing the input message and contents of messages translated into the languages respectively set by the plurality of user terminals to the on-line chat service.
